(19) United States
(12) Patent Application Publication
(10) Pub. No.: US 2015/0127771 A1
(43) Pub. Date: May 7, 2015

(54) Method and Apparatus

(71) Applicants: Markus Bauer-Hermann, Munich (DE); Robert Seidl, Konigsdorf (DE); Stefan Baur, Nurnberg (DE)

(72) Inventors: Markus Bauer-Hermann, Munich (DE); Robert Seidl, Konigsdorf (DE); Stefan Baur, Nurnberg (DE)

(73) Assignee: Nokia Solutions and Networks Oy, Espoo (FI)

(21) Appl. No.: 14/397,917

(22) PCT Filed: May 8, 2012
(86) PCT No.: PCT/EP2012/058431

§ 371 Date: Oct. 30, 2014

(51) Int. Cl. H04L 29/08

(52) U.S. Cl. CPC H04L 67/02
USPC 709/217

(57) ABSTRACT

A method includes causing a first request to be sent; receiving a response to said request including a script; causing a second request to be sent including parameter information; running said script to determine type information associated with said parameter information; and causing said type information to be sent.

The present invention relates to a method and apparatus and in particular but not exclusively to a method and apparatus for monitoring applications.

Users often access different services, such as Internet services. These services may be provided by a service provider. A user will access these services via a user device or a user equipment. The user device will connect to the service provider via network protocols such as TCP/IP.

Some web browsers use DOM (document object model) or the like to render documents. This document may be a HTML (hypertext mark-up language) page. A DOM API (application programming interface) may be used to modify or look at a web page. The DOM is used by a script to see the browser state and the HTML tags of the web page. The HTML page is rendered in the browser. The browser parses the HTML page. The DOM will then cause the page to be displayed.

A user may interact with the browser and enter data which is required by the service provider. This data can take any suitable form and may for example be sign in data or the like. This data will need to be sent to the service provider.

According to an aspect, there is provided a method comprising: causing a first request to be sent; receiving a response to said request comprising a script; causing a second request to be sent comprising parameter information; running said script to determine type information associated with said parameter information; and causing said type information to be sent.

The causing a second request to be sent may be responsive to a submission event.

The submission event may be a submission of a form event.

Running of said script may cause the detection of a dynamic generated form.

The running of said script may cause mapping of type information to said parameters of a submitted form.

The parameter information may comprises name value pair information.

The method may comprise causing at least one of said first request, said second request and said type information to be sent to a gateway or a proxy.

The method may comprise causing at least one of said first and second requests to be sent to a service provider.

The method may comprise causing said type information to be sent to a third party.

At least one of said requests may comprise an HTTP request.

The response may comprise an HTTP response.

The method may comprise running said script in a sand box.

According to another aspect, there may be provided an apparatus configured to carry out any of the above method steps.

A computer program comprising program code means arranged to perform the method may be provided. The computer program may be stored and/or otherwise embodied by means of a carrier medium.

According to another aspect, there is provided an apparatus comprising at least one processor and at least one memory including computer code for one or more programs, the at least one memory and the computer code configured, with the at least one processor, to cause the apparatus at least to: cause a first request to be sent; receive a response to said request comprising a script; cause a second request to be sent comprising parameter information; run said script to determine type information associated with said parameter information; and cause said type information to be sent.

The at least one memory and the computer code may be configured, with the at least one processor, to cause the apparatus to cause a second request to be sent is responsive to a submission event.

The submission event may be a submission of a form event.

The at least one memory and the computer code may be configured, with the at least one processor, to cause the detection of a dynamic generated form.

The at least one memory and the computer code may be configured, with the at least one processor, to cause mapping of type information to said parameters of a submitted form.

The said parameter information may comprise name value pair information.

The at least one memory and the computer code may be configured, with the at least one processor, to cause at least one of said first request, said second request and said type information to be sent to a gateway or a proxy.

The at least one memory and the computer code may be configured, with the at least one processor, to cause at least one of said first and second requests to be sent to a service provider.

The at least one memory and the computer code may be configured, with the at least one processor, to cause said type information to be sent to a third party.

At least one of said requests may comprise an HTTP request.

The response may comprise an HTTP response.

The at least one memory and the computer code may be configured, with the at least one processor, to cause running of said script in a sand box.

According to an aspect, there is provided an apparatus comprising: means for causing a first request to be sent; means for receiving a response to said request comprising a script; means for causing a second request to be sent comprising parameter information; means for running said script to determine type information associated with said parameter information; and means for causing said type information to be sent.

The means for causing said second request to be sent may be responsive to a submission event.

The submission event may be a submission of a form event.

The running means may be for running said script to cause the detection of a dynamic generated form.

The running means may be for running said script to cause mapping of type information to said parameters of a submitted form.

The parameter information may comprise name value pair information.

The means for causing said first request to be sent may be for causing said first request to be sent to a gateway or proxy and/or the means for causing said second request to be sent may be for causing said second request to be sent to a gateway or proxy and/or the means for causing the type information to be sent may be for causing the type information to be sent to a gateway or a proxy.

The means for causing said first request to be sent may be for causing said first request to be sent to a service provider and/or the means for causing said second request to be sent may be for causing said second request to be sent to a service provider.

The means for causing said type information to be sent may be for causing said type information to be sent to a third party.

At least one of said requests may comprise an HTTP request.

The response may comprise an HTTP response.

The running means may run said script in a sand box.

The apparatus may be provided in a device such as a computer, smart phone, user equipment or the like.

Some embodiments are now described, by way of example only, with reference to the accompanying drawings in which:

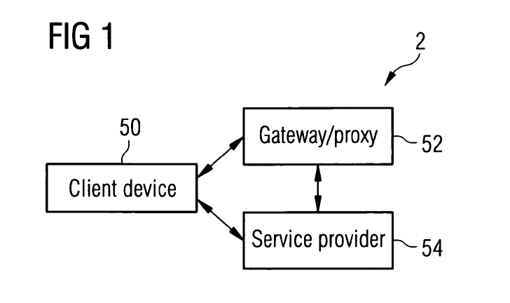

FIG. 1 is a block diagram of a system;

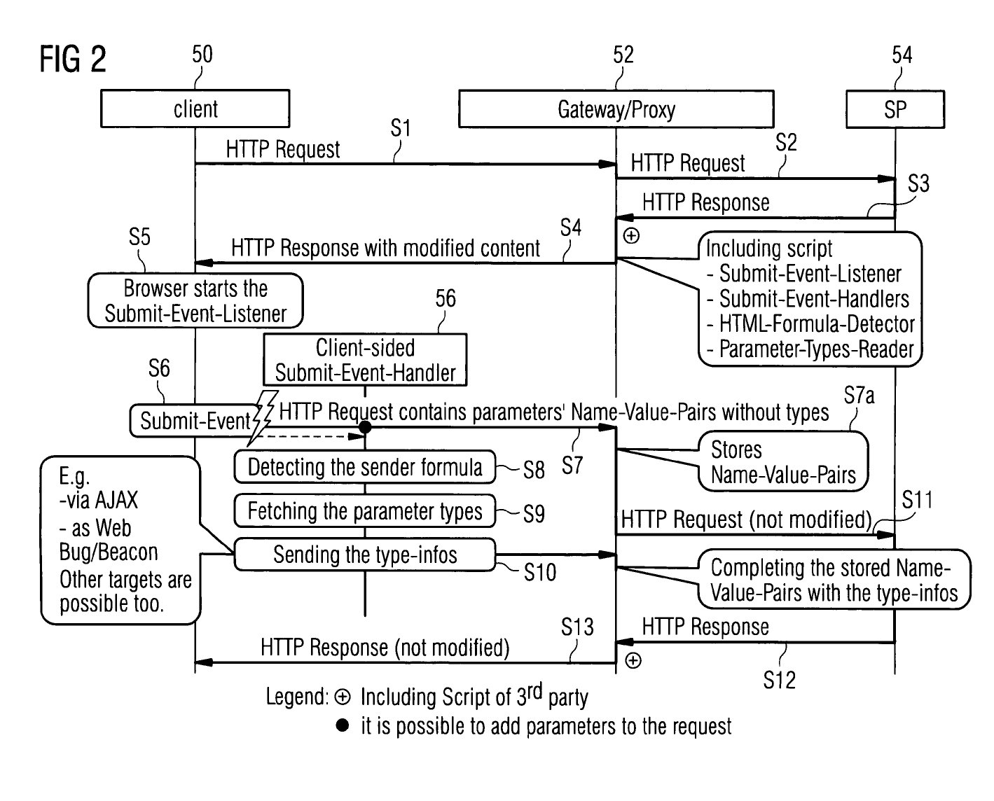

FIG. 2 shows a flow of a first embodiment;

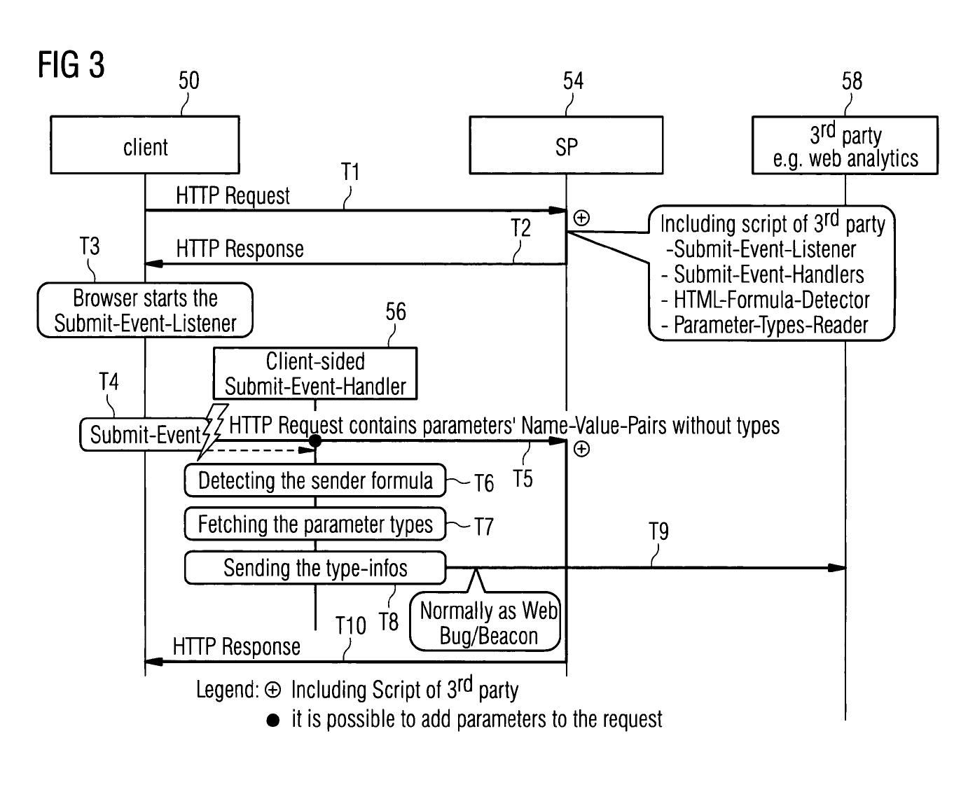

FIG. 3 shows a flow of a second embodiment;

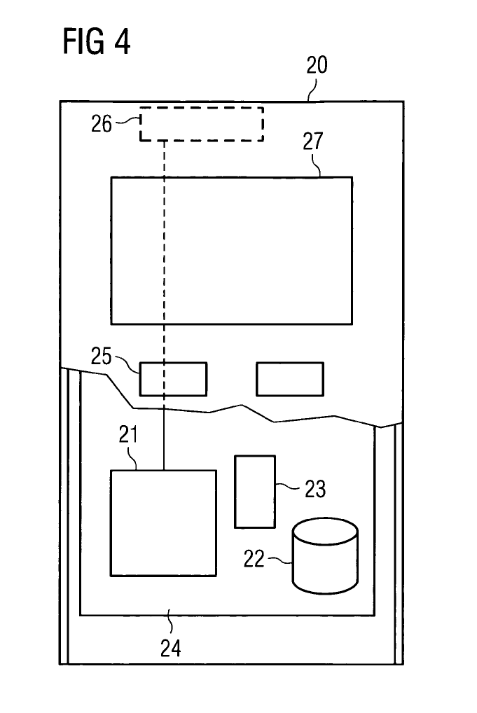

FIG. 4 schematically shows a client device;

FIG. 5 schematically shows a gateway or proxy device;

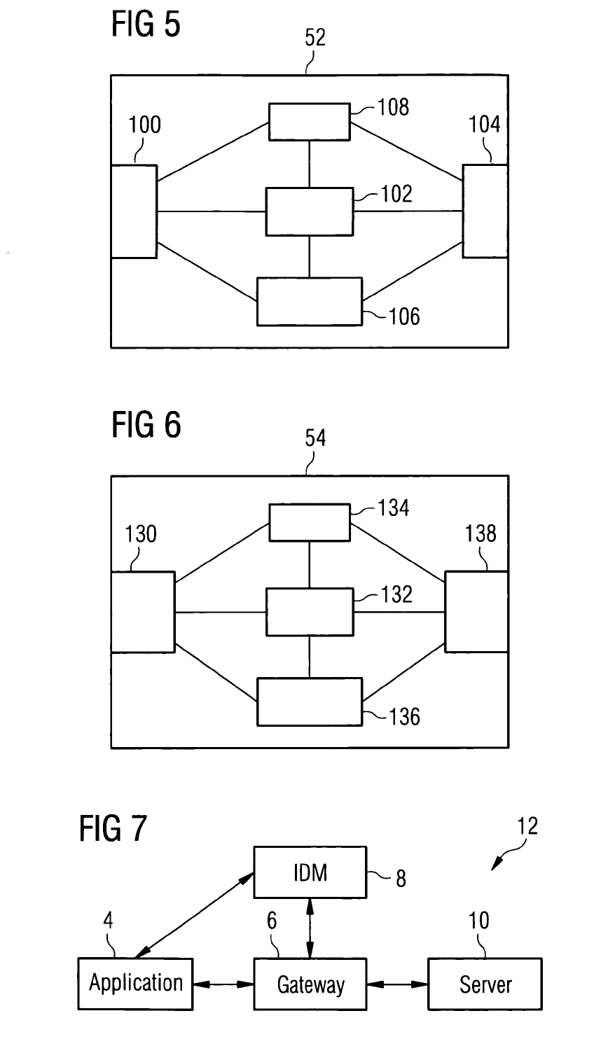

FIG. 6 schematically shows a service provider; and

FIG. 7 shows a block diagram of a second system.

FIG. 1 is a block diagram of a system, indicated generally by the reference numeral 2. The system 2 comprises a client device 50, a gateway 52, and a service provider 54.

The client device 50 may be any suitable device. The device may be a wireless or wired communication device. Non-limiting examples include a mobile station (MS) such as a mobile phone or what is known as a ‘smart phone’, a portable computer provided with a wireless interface card or other wireless interface facility, a net book, a tablet, a personal data assistant (PDA) a computer, a terminal or any combinations of these or the like.

The client device is configured in some embodiments to connect to a service provider 54 via the gateway or proxy 52 or in some embodiments, the client device may connect to the service provider, not via this gateway or proxy.

FIG. 7 shows a block diagram of an alternative system. The system 12 comprises an application 4, a gateway 6, an identity management system (IDM) 8 and a server 10. The gateway 6 is provided between the application 4 and the server 10. The gateway 6 is also operatively coupled to the IDM 8. Typically, the application 4 is under the control of a user and the server 10 is at a service provider. In use, the user at the application 4 provides credentials (such as a username and password, although, of course, other credentials could be used) to the gateway 6. The gateway 6 and the identity management system 8 may have a secured connection. The gateway 6 can use the secured connection to verify the user credentials at the identity management system (IDM) 8 in order to authenticate the user. Once authenticated, any service requests issued by the user via the application 4 are monitored by the gateway 6. The gateway 6 may monitor individual packets of data passing through the gateway. Furthermore, the gateway 6 is adapted to modify packets of data to insert the appropriate credentials for the user for the particular service that is being accessed.

Alternatively or additionally, there may be user authentication of the application by the IDM. There may be user authentication with a login-page with redirection to the server if passed. The IDM may thus have a user interface for user authentication.

In FIGS. 1 and 7, the components are shown as being directly connected to one another. This is possible in some embodiments. However it may be more usual for there to be other components such as a network and/or one or more further components between each of the components. For example one or more of the components may be connected by the Internet, a wired network and/or a wireless network.

The client device may be under the control of a user and may have a web browser or other application with an integrated script engine. The script engine provides an interface with the capability of interconnecting a suitably written application with a scripting language. The service provider may be a web server or provider of a web application. Embodiments, however, are not limited to use with web browsers and web servers.

A browser at the client renders a DOM (document object model) tree which was previously generated by parsing a HTML (hypertext mark-up language) source code. The DOM tree is rendered as a graphical representation such as a web page. With client sided dynamical browser scripts, e.g. JavaScript (e.g. ECMA standard number-262), VBScript or JScript, the DOM tree can be manipulated by inserting, deleting or modifying parts of the DOM tree. This includes dynamical generation of forms and input fields (HTML forms).

Some embodiments may be used for web surveillance. By way of example only, this web surveillance may be used for web analysis, sometimes referred to as web analytics. In other embodiments, this surveillance may be used in order to determine a phishing attack or the like.

For dynamically generated input fields currently the web surveillance component may not be aware of the type of the generated input field (e.g. radio button, drop down, check box, password field, text field). Some versions of HTML may know more input field types such as: fields for email, URL, number, range, date, time, day, week, month, year or the like.

The web surveillance component may not assign the posted value to the originating field (e.g. it may not be possible to analyze which input fields are used, to what extent the input fields have been used and which of these options the user could choose from).

Some known gateways and proxies support parsing of static outgoing HTML content, but do not support dynamic HTML content. Some known tracking or advertising technologies (e.g. by outsourced web analytics) are designed to work on the client side, but do not support dynamically generated fields or forms. Browser plug-ins is able to observe dynamically generated elements (e.g. Mozilla Firefox add-on Firebug). However plug-ins need to be installed to the browser first and thus act only with user consent.

In the case of for example, the identity management system IDM Gateway, these dynamically generated forms and input fields may not be recognized by parsing the static HTML content which is send over the gateway or proxy to the client by the service provider. This means, that the gateway or proxy can parse the HTML content, before it passes through the client.

For example the service provider response has HTML content with a form containing the text parameter varA and the password parameter varB (see below).

<html>
...
<body>
...
<form action=“” method=“POST”>
<input type=“text” name=“varA” />
<input type=“password” name=“varB” />
<input type=“submit” value=“send to service provider” />
</form>
...
</body>
</html>

If the client clicks or in any other way selects the submit option, the service provider receives (over the gateway or proxy) a POST request containing the parameters varA and varB as name-value-tuples. A POST request is one example of a request method supported by the HTTP protocol. The POST request may be used when the client needs to send data to the server as part of the request, such as when uploading a file or submitting a completed form.

Some embodiments provide a technique for observing dynamically generated elements that may enable e.g. CSP's (communication service providers) to extend tracking mechanisms for e.g. dynamically generated HTML forms, which allow the tracker to recognise the user's preferred input selections. The client script (submit-event-listener) may be executed inside the browser's sandbox by the web browser. Therefore there may be no work around needed for protection mechanisms.

Some embodiments may be used by e.g. the tracking industry to legally trace the user's behaviour. Alternatively or additionally some embodiments may be used by security network components to observe the outgoing HTTP (hypertext transfer protocol) traffic (e.g. SaaS (Security as a Service product)).

Alternatively or additionally some embodiments may be used with operator side password management. Here this mechanism is used for detecting dynamic password fields (e.g. POST request) with the aim of storing them in a database for providing SSO (single sign on) to the user. This may be used with the IDM gateway.

The types can be determined by parsing the static HTML content, before the client gets the HTML content. In some embodiments, the service provider response has a HTML content without a form, but within a “special” script (which may be provided by the service provider), which manipulates the DOM to include a form, client-sided.

<html>
...
<script type=“javascript” src=“the_special_script.js” />
...
<body onLoad=“add_an_example_form( )” ...>
...
<!--

Here the form will be included in the DOM by the given script, in some embodiments. Currently the gateway or proxy does not know anything about the form. Some embodiments may address this issue so that the gateway or proxy will know at least some and in some embodiments all the data information of each form submission.

-->
...
</body>
</html>

The example above can although be realized with JScript, VBscript etc.

Thus in order to recognize forms generated by DOM manipulation the client side script is provided which observes all submit events of the page. Once triggered by such an event, the client side script will check the tree for dynamically added fields (e.g. password fields) and proceeds by sending the collected information back to the network component (e.g. gateway or proxy). This can be done in any suitable way. For example this may be done by:
adding the information to the POST request/GET request;
issuing a separate AJAX request (Asynchronous JavaScript and XML). AJAX is used to create asynchronous web applications on the client side. AJAX allows the sending of data to and retrieval of data from a server;
serializing the information and appending it to a newly generated DOM object as source address (e.g. an image known as Web bug/beacon technology); and
others (Flash, ActiveX, Java applet, etc.)

Reference is made to FIG. 2 which shows a sequence followed for a gateway-proxy embodiment. The message flow is shown between a client 50, a gateway/proxy 52 and a service provider 54.

In a first step S1, an HTTP request is sent from the client to the gateway/proxy 52. In step S2, the HTTP request is sent from the gateway/proxy 52 to the service provider 54. In step S3, the service provider 54 provides a HTTP response to the gateway/proxy 52.

The gateway/proxy provides a HTTP response with a modified content in step S4. In particular, the gateway/proxy includes in the HTML content a script, in order that the script is a part of the HTML content. The gateway/proxy also modifies the header to reflect the larger payload. The gateway/proxy includes scripts for Submit-Event-Listener, Submit-Event-Handlers, HTML-Formula-Detector and Parameter-Types-header. The function of these scripts will be described in more detail later. This script may not be detected as a virus or a Trojan, normally. The browser may see this script as an unmodified response of the service provider.

In step S5, at the client 50, the script will be started by the browser's script engine (e.g. javascript functions can be added to the “onLoad”-Event). In some embodiments the client does not see the effects of the included script, because it runs in the background). The client script (submit-event-listener) will be executed inside the browser's sandbox by the web browser. Therefore there is no work around needed for protection mechanisms. The sandbox is one example of a security mechanism which can be used to run untrusted programs or the like. A sandbox typically provides a set of resources for guest programs to run. It should be appreciated that in other embodiments, the script can be run in alternative environments.

The browser starts the submit-event-listener. This monitors for the occurrence of events, especially submit-events of forms. An event can be any suitable event. By way of example the event may be the submission of information to the service provider, for example by way of an HTTP request. Other events may be Mouse-Events (mouse-enter, mouse-leave, mouse-move, mouse clicks etc.), Input-Field-Events (onfocus, onblur, events for keys e.g. key pressed etc.)

In step S6, the client clicks or prompts a submit-event. As shown schematically a client-sided submit-event-handler 56 is provided at the client. This effectively is a computer program which is configured to observe and handle the events.

The client submits in step S7 the event in an HTTP request which includes parameters associated with the event. The HTTP request is submitted from the client to the gateway/proxy. The HTTP request contains the parameters Name-Value-Pairs without types. In other words just the data is submitted without an indication as to the nature, kind or type of that data.

In step S7a, the Name-Value-Pairs are stored at the gateway/proxy 52. This is followed by step S11 where an unmodified HTTP request is sent to the service provider. There may be Network-Transparency where in this case the services do not see that there is a proxy or gateway in the flow. In some embodiments, S11 may take place generally in parallel with one or more of steps S8 or S9.

In step S8, the submitted formula is detected by the client-sided submit-event-handler. A HTML-document can contain more than one form. Therefore embodiments are configured to detect the form (if unknown), on which the user clicked or otherwise activated. The script explores the current DOM state, in order to find out the input-field-types of the submitted form.

In step S9, the parameters types are fetched by the client-sided submit-event-handler. The parameter types are the nature or type of the data submitted in the HTTP request. This may for example identify a user name, a password, identity credentials or any other type of data. A text area may contain multi-lined text data. “Options” are used to collect a set of possible values. HTML input types are examples, such as email, URL, number, range, time etc. However, any other possible types may be alternatively or additionally determined.

In step S10, the type-information is sent by the client-sided submit-event-handler to the gateway/proxy 52. By way of example only this information may be via AJAX or as Web Bug/Beacon. A web bug is a technique used for example to track who is reading a web page, when, and from what computer. The gateway/proxy will complete the stored name-value pairs with the type-information.

In step S12, an HTTP response is sent from the service provider 54 to the gateway/proxy 52.

In step S13, the HTTP response is sent from the gateway/proxy 52 to the client 50. The HTTP response can be modified according to step S4.

Reference is made to FIG. 3 which shows a sequence flow for a service provider—third party embodiment.

The message flow is shown between a client 50, a service provider 54 and a third party 58. The third party may be any suitable third party such as a web analyser.

In a first step T1, an HTTP request is sent from a client to the service provider 54.

The service provider 54 provides a HTTP response with a modified content in step T2. This content is modified as described in relation to step S2 of FIG. 2. However the script will be from the third party.

In step T3, at the client 50, the browser starts the submit-event-listener. This is as described in relation to Step S5 of FIG. 2.

In step T4, the client submits an event (as described in relation to Step S6 of FIG. 2).

Again, a client-sided submit-event-handler 56 is provided at the client. The HTTP request which is submitted in step T5 from the client to the service provider contains Name-Value-Pairs (as described in relation to Step S7 of FIG. 2). The HTTP request contains parameters Name-Value-Pairs without types. The service provider will include the script of a third party.

In step T6, the sender formula is detected by the client-sided submit-event-handler (as described in relation to Step S8 of FIG. 2).

In step T7, the parameters are fetched by the client-sided submit-event-handler 56 (as described in relation to Step S9 of FIG. 2).

In step T8, the type-information is sent by the client-sided submit-event-handler to the third party 58. By way of example only this information may be via AJAX as Web Bug/Beacon. The third party (SP) gets only the name-value-pair in step T9. The type-information is not used by the SP, because the SP declares the required types of the parameters in the outgoing HTTP-responses (dynamically via DOM scripting or static in the HTML content). The gateway/proxy needs the name-value-type-triples for realizing e.g. SSO via password-lists of users (type=“password”).

In step T10, the HTTP response is sent from the service provider 52 to the client 50. The HTTP response may not be modified.

Some embodiments may provide improved Web surveillance technologies. This may provide better statistics with a focus on dynamic client sided HTML content. Improved tracking technology may be provided by circumventing a protection mechanism relying on dynamic HTML.

Another advantage of some embodiments considers the security aspect of identifying phishing pages using overlaying, dynamically generated input fields. The input field signature of the HTML form will be similar to the original, but the receiving party will be different. This would allow identifying phishing pages in an easy manner. In other words the gateway/proxy or third party would be able to determine if the HTTP request goes to a server which differs from the service provider server. This can be determined to be a phishing attack.

In some embodiments, the script for fetching the action-links of the forms may be modified to observe a change-event of the action-links. If a cross-side-script (XSS) tries to change the domain of an action-link, this may be detected in some embodiments.

FIG. 4 showing a schematic, partially sectioned view of a user device. The device 20 is configured to receive via an interface 26. The device is also provided with at least one data processing entity 21, at least one memory 22 and other possible components 23 for use in software and hardware aided execution of tasks it is designed to perform. The at least one memory may be provided by one or more memories or by one or more databases. The data processing, storage and other relevant apparatus can be provided on an appropriate circuit board and/or in chipsets. This apparatus is denoted by reference 24.

The user may control the operation of the device by means of a suitable user interface 25 which may be integral or separate from the processing part of the device. A display 27 can be also provided which may be integral or separate from the processing part of the device.

FIG. 5 shows schematically a gateway 52. The Gateway 52 has a first interface 100 and a second interface 104.

The first interface is configured to interface with the client 50. The second interface 104 is configured to interface with the service provider. The interfaces may be wired and/or wireless.

The Gateway 52 has a processor 102. The processor may be a single processor or may comprise two or more processors. The Gateway 52 may have a first memory 108 which is configured to store the script. This is the script for supervising the form-submit-events, and determining the form-input-field-types.

The Gateway 52 may have a second memory 106 which is configured to store data. For example, this store may store the name-value-pairs with the type-information. In some embodiments, a single memory may provide the first and second memories. In alternative embodiments, more than two memories may be provided.

In some embodiments, the same memory or store may be used to store both (the script and the name-value-type-triples).

Reference is made to FIG. 6 which shows the service provider 54. The service provider has a first memory 134. The first memory 134 is configured to store name value pairs. The service provider 54 has a second memory 136. The second memory 136 is configured to store the script. Again, the first and second memories may be provided by a common memory. Alternatively, more than two memories may be provided. The service provider has an interface 130 which is configured to interface with the client 50. The service provider has a second interface 138. This second interface allows the service provider 54 to receive the script from the third party. In some embodiments, the communication between the client and the third party may be via the service provider. The interfaces may be wired and/or wireless.

In some embodiments, at least some of the function of the gateway or proxy of FIG. 2 may be provided by an identity management system (IDM) such as shown in FIG. 7. In some embodiments, a gateway will still be provided. The Gateway and the IDM may have a secured connection. The Gateway can use the secured connection to verify the user credentials at the IDM in order to authenticate the user. Once authenticated, any service requests issued by the user are monitored by the gateway. The Gateway may modify packets of data to insert the appropriate credentials for the use of the particular service that is being accessed. The IDM system may provide a single-sign-on procedure. In one example of a single-sign-on arrangement, a number of service providers trust an identity provided to authenticate a user. Once the user has completed a single authentication step at the identity provider, the user is able to access his account at any web application that trusts the authentication process of that identity provider. In some embodiments, the IDM system (via IDM Gateway) may include the script in the HTTP response.

Web analytics may be improved it if is also possible to observe dynamic added forms. Statistics about the usage of form input-fields selected by input-field-types can be collected. Information about how many forms are generated by client-sided scripts, and how many forms are responded in clear text format by service providers may be collected.

Embodiments may provide detection of dynamic generated HTML/DOM-forms on the client-side and/or mapping of type information to the parameters (name-value-tuples) of submitted form.

Some embodiments may have one or more of the following advantages:

1. Improving the usage of input-fields of HTML/DOM-forms for web analytics.
2. Leverage form-processing (previously only for static forms possible) to web 2.0+dynamic technology.
3. Monitoring, which data goes to service provider, is good for example for Data Loss Prevention.

### 4. Used for SSO.

5. Device/Browser independent mechanism, because of using the gateway/proxy and the script.

Some embodiments may have a service level agreement or the like between a telecommunications company and the user for using the gateway/proxy. In some cases, it might be necessary to re-enable surveillance of the HTTP traffic and the origination actions. For example this may be to prevent Trojans from submitting dynamically created forms filled by the browser's auto-completion tool.

The required data processing apparatus and functions of the entities described above may be provided by means of one or more data processors. The described functions at each end may be provided by separate processors or by an integrated processor. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non limiting examples. The data processing may be distributed across several data processing modules. A data processor may be provided by means of, for example, at least one chip. Appropriate memory capacity can also be provided in the relevant devices. The memory or memories may be of any type suitable to the local technical environment and may be implemented using any suitable data storage technology, such as semiconductor based memory devices, magnetic memory devices and systems, optical memory devices and systems, fixed memory and removable memory.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof. The software may be stored on such physical media as memory chips, or memory blocks implemented within the processor, magnetic media such as hard disk or floppy disks, and optical media such as for example DVD and the data variants thereof, CD.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more of any of the other embodiments previously discussed.

1-26. (canceled)

27. A method comprising:
causing a first request to be sent;
receiving a response to the request comprising a script;
running the script to: detect a second request sent comprising parameter information, determine type information associated with the parameter information, and send the type information to be sent.

28. A method as claimed in claim 27, wherein causing a second request to be sent is responsive to a submission event.

29. A method as claimed in claim 28, wherein the submission event is a submission of a form event.

30. A method as claimed in claim 27, wherein running the script causes the detection of a dynamic generated form.

31. A method as claimed in claim 27, wherein running the script causes mapping of type information to the parameters of a submitted form.

32. A method as claimed in claim 27, wherein the parameter information comprises name value pair information.

33. A method as claimed in claim 27, comprising causing at least one of the first request, the second request and the type information to be sent to a gateway or a proxy.

34. A method as claimed in claim 27, comprising causing at least one of the first and second requests to be sent to a service provider.

35. A method as claimed in claim 34, comprising causing the type information to be sent to a third party.

36. A method as claimed in claim 27, wherein at least one of the requests comprises an HTTP request.

37. A method as claimed in claim 27, wherein the response comprises an HTTP response.

38. A method as claimed in claim 27, comprising running the script in a sand box.

39. A computer program comprising computer executable instructions which when run, perform the method comprising:
causing a first request to be sent;
receiving a response to the request comprising a script;
running the script to: detect a second request sent comprising parameter information, determine type information associated with the parameter information, and send the type information to be sent.

40. An apparatus comprising:
at least one processor configured to:
cause a first request to be sent;
receive a response to the request comprising a script;
run the script to: detect a second request comprising parameter information, determine type information associated with the parameter information, and cause the type information to be sent.

41. An apparatus as claimed in claim 40, wherein the at least one memory and the computer code are configured, with the at least one processor, to cause the apparatus to cause a second request to be sent is responsive to a submission event.

42. An apparatus as claimed in claim 41, wherein the submission event is a submission of a form event.

43. An apparatus as claimed in claim 40, wherein the at least one memory and the computer code are configured, with the at least one processor, to cause the detection of a dynamic generated form.

44. An apparatus as claimed in claim 40, wherein the at least one memory and the computer code are configured, with the at least one processor, to cause mapping of type information to the parameters of a submitted form.

45. An apparatus as claimed in claim 40, wherein the parameter information comprises name value pair information.

46. An apparatus as claimed in claim 40, wherein the at least one memory and the computer code are configured, with the at least one processor, to cause at least one of the first request, the second request and the type information to be sent to a gateway or a proxy.
